(19) United States
(12) Patent Application Publication
(10) Pub. No.: US 2015/0106509 A1
(43) Pub. Date: Apr. 16, 2015

(54) METHOD FOR REPRESENTING USAGE AMOUNT OF MONITORING RESOURCE, COMPUTING DEVICE, AND RECORDING MEDIUM HAVING PROGRAM RECORDED THEREON FOR EXECUTING THEREOF

(71) Applicant: TEEMSTONE, Seoul (KR)

(72) Inventors: Bum Sik Lee, Seongnam-si Gyeonggi-do (KR); Chang Won Seol, Seongnam-si Gyeonggi-do (KR); Ja Heon Ku, Seoul (KR)

(21) Appl. No.: 14/399,556

(22) PCT Filed: May 6, 2013
(86) PCT No.: PCT/KR2013/003927

§ 371 Date: Nov. 7, 2014

(30) Foreign Application Priority Data
May 7, 2012 (KR) 10-2012-0048195

(51) Int. Cl. H04L 12/26; H04L 12/911

(52) U.S. Cl. CPC H04L 43/0876; H04L 47/70
USPC 709/224

(57) ABSTRACT

A method of representing a usage of a monitoring resource includes designating monitoring target processes based on a weight file including a resource weight assigned according to resource importance for each of at least one process, minimum and maximum values of a corresponding resource weight and a resource identifier, applying the resource weight to resource items including CPU, memory and I/O usage rates, the resource items influencing on each of the monitoring target processes and visually representing each of the monitoring target processes according to the applied resource weight by a user request or periodically. Therefore, this application may apply a resource weight according to a resource importance being used by each of processes so that a user may check and actively deal with a system status.

### TECHNICAL FIELD

This application relates to a technology of representing a monitoring resource usage and more particularly to a method of representing a usage of a monitoring resource, a computing apparatus and a storage medium recording a program executing the same representing a usage of a monitoring resource for at least one process designated in a plurality of processes.

### BACKGROUND ART

Recently, a computer system performance is very rapidly improved with a development of an IT industry. A resource of the computer system is managed by an operating system. The operating system corresponds to a system software being operated as an interface between a user and a computer hardware to manage an input/output and use of a memory, a disc and a plurality of external devices and to cause a program to usefully use a hardware.

The operating system manages a CPU access method, a memory, a file system of programs to provide an environment where the program is executed. The user may measure whether an unusual operation exists based on process information managed by the operating system.

For example, the user may monitor and manage each of work processes. When a usage and a variation of a usage rate in resource items of the system influences on the work processes, the user decides this case as malfunction state and deal with this malfunction state. For another example, the user may monitor and manage each of work processes. When a usage and a variation of a usage rate in resource items of the system is not processed in a process response time being previously expected the user decides this case as malfunction state and deal with this malfunction.

However, for solving a problem for the malfunction state, the user should analyze all of operating processes in the system and search for problem issuing processes and these procedures need much time and effort.

Korean Patent Publication No. 10-2009-0081749 relates to a resource monitoring method of an application program and may monitor the resource for the application program based on a single process with a plurality of threads.

Korean Patent Publication No. 10-2009-0122168 relates to a computer resource monitoring system and may provide whether an unusual status exists by each of devices forming a computer system and a method of dealing with the unusual status.

### Technical Problem

Example embodiments of the present invention propose a method of representing a usage of a monitoring resource, a computing apparatus and a storage medium storing the method capable of applying a resource weight according to resource importance being used by each of at least one process to cause a user to check and actively deal with a system status.

Example embodiments of the present invention propose a method of representing a usage of a monitoring resource, a computing apparatus and a storage medium storing the method capable of visually representing each of at least one process according to a resource weight to cause a user to monitor and manage a system management status and condition based on a workflow from beginning to end of a chart.

Example embodiments of the present invention propose a method of representing a usage of a monitoring resource, a computing apparatus and a storage medium storing the method capable of representing a resource item being used by each of at least one process by a user request or periodically to cause a user to conveniently monitor and manage a system management status and condition.

Example embodiments of the present invention propose a method of representing a usage of a monitoring resource, a computing apparatus and a storage medium storing the method capable of representing at least one process according to a resource weight by a multi form graph to check or expect a process pattern according to a process status of a current time and a time flow.

### Technical Solution

In some embodiments, a method of representing a usage of a monitoring resource is performed on a computing apparatus executing a plurality of processes. The method includes designating monitoring target processes based on a weight file including a resource weight, minimum and maximum values of the resource weight and a resource identifier, the resource weight being assigned according to resource importance for each of at least one process, applying the resource weight to resource items including CPU, memory and I/O usage rates, the resource items influencing on each of the monitoring target processes and visually representing each of the monitoring target processes according to the applied resource weight by a user request or periodically.

In one embodiment, the method may further include informing an unusual operation of a corresponding process to a system operator when the resource weight associated with a corresponding resource for each of the monitoring target processes is less than the minimum value. In another embodiment, the method may further include informing the unusual operation of the corresponding process to the system operator when the resource weight associated with the corresponding resource for each of the monitoring target processes exceeds the minimum value.

In one embodiment, visually representing each of the monitoring target processes may further include detecting a resource having a maximum resource weight associated with a corresponding resource for each of the monitoring target processes when the correspond resource weight is applied and representing the resource having the maximum resource weight with a specific color or pattern being designated by the system operator.

In some embodiments, a computing apparatus representing a usage of a monitoring resource includes a process designating unit configured to designate monitoring target processes based on a weight file including a resource weight, minimum and maximum values of the resource weight and a resource identifier, the resource weight being assigned according to resource importance for each of at least one process, a weight applying unit configured to apply the resource weight to resource items including CPU, memory and I/O usage rates, the resource items influencing on each of the monitoring target processes and a resource status representing unit configured to visually represent each of the monitoring target processes according to the applied resource weight by a user request or periodically.

In one embodiment, the computing apparatus representing the usage of the monitoring resource may further include a weight error informing unit configured to inform an unusual operation of a corresponding process to a system operator when the resource weight associated with a corresponding resource for each of the monitoring target processes is less than the minimum value. In one embodiment, the weight error informing unit may inform the unusual operation of the corresponding process to the system operator when the resource weight associated with the corresponding resource for each of the monitoring target processes exceeds the minimum value.

In one embodiment, the resource status representing unit may detect a resource having a maximum resource weight associated with a corresponding resource for each of the monitoring target processes when the correspond resource weight is applied and may represent the resource having the maximum resource weight with a specific color or pattern being designated by the system operator.

In some embodiments, a non-transitory computer-readable medium storing a program executing a method of representing a usage of a monitoring resource, the method being performed on a computing apparatus executing a plurality of processes, the method includes designating monitoring target processes based on a weight file including a resource weight, minimum and maximum values of the resource weight and a resource identifier, the resource weight being assigned according to resource importance for each of at least one process, applying the resource weight to resource items including CPU, memory and I/O usage rates, the resource items influencing on each of the monitoring target processes and visually representing each of the monitoring target processes according to the applied resource weight by a user request or periodically.

### Technical Effects

A method of representing a usage of a monitoring resource, a computing apparatus and a storage medium storing the method according to example embodiments of the present invention may apply a resource weight according to resource importance being used by each of at least one process to cause a user to check and actively deal with a system status.

A method of representing a usage of a monitoring resource, a computing apparatus and a storage medium storing the method according to example embodiments of the present invention may visually represent each of at least one process according to a resource weight to cause a user to monitor and manage a system management status and condition based on a workflow from beginning to end of a chart.

A method of representing a usage of a monitoring resource, a computing apparatus and a storage medium storing the method according to example embodiments of the present invention may represent a resource item being used by each of at least one process by a user request or periodically to cause a user to conveniently monitor and manage a system management status and condition.

A method of representing a usage of a monitoring resource, a computing apparatus and a storage medium storing the method according to example embodiments of the present invention may represent at least one process according to a resource weight by a multi form graph to check or expect a process pattern according to a process status of a current time and a time flow.

### DESCRIPTION OF DRAWINGS

FIG. 1 is a block diagram illustrating a computing apparatus according to an example embodiment of the present invention.

FIG. 2 is a block diagram illustrating a resource status representing apparatus of in FIG. 1.

FIG. 3 is a stacked vertical bar graph representing each of processes by a process status representing unit in FIG. 2.

FIG. 4 is a stacked line graph representing each of processes by a process status representing unit in FIG. 2.

FIG. 5 is a graph representing each of processes by a process status representing unit in FIG. 2.

FIG. 6 is a flowchart illustrating a procedure executing a resource status representing apparatus in FIG. 1.

FIGS. 7 and 8 are example diagrams of execution procedure in FIG. 6.

### MODE FOR INVENTION

The embodiments and the configurations depicted in the drawings are illustrative purposes only and do not represent all technical scopes of the invention, so it should be understood that various equivalents and modifications may exist at the time of filing this application. Although a preferred embodiment of the disclosure has been described for illustrative purposes, those skilled in the art will appreciate that various modifications, additions and substitutions are possible, without departing from the scope and spirit of the invention as disclosed in the accompanying claims.

Terms and words used in the specification and the claims shall be interpreted as to be relevant to the technical scope of the invention based on the fact that the inventor may property define the concept of the terms to explain the invention in best ways.

The terms “first” and “second” can be used to refer to various components, but the components may not be limited to the above terms. The terms will be used to discriminate one component from the other component. For instance, the first component may be referred to the second component and vice versa without departing from the right of the disclosure.

When a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific embodiments and have no intention to limit the disclosure. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Identification letters (e.g., a, b, c, etc.) in respective steps or operations are used for the sake of explanation and do not describe any particular order. The respective operations may be changed from a mentioned order unless specifically mentioned in context. Namely, respective steps may be performed in the same order as described, may be substantially simultaneously performed, or may be performed in reverse order.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

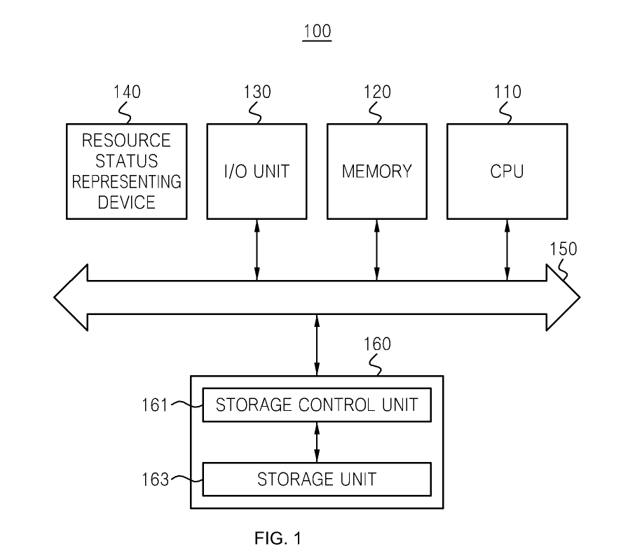

FIG. 1 is a block diagram illustrating a computing apparatus according to an example embodiment of the present invention.

Referring to FIG. 1, the computing apparatus 100 includes a CPU (Central Processing Unit) 110, memory 120, I/O unit 130, resource status representing device 140, system bus 150 and storage device 160.

The CPU 110 is connected with the memory 120, I/O unit 130, resource status representing device 140, system bus 150 and storage device 160 through the system bus 150. The CPU 110 executes a process (i.e., a task) being performed by a user. In one embodiment, the CPU 110 may perform a multitasking between a plurality of processes. For example, when an execution command of a second process is received in a procedure processing a first process, the CPU 110 may perform the multitasking between the first and second processes according to a scheduling algorithm.

The CPU 110 accesses the storage device 160 through the system bus 150 to move a specific program to the memory 120 and to execute the specific program as the second process. The second process may use the CPU 110, memory 120 and I/O unit 130 when the second process is executed and a usage of the CPU 110, memory 120 and I/O unit 130 may be monitored by the first process.

The memory 120 may temporarily store a process being processed on the CPU 110. For example, the memory 120 may store a process decreasing resource monitoring data being processed on the CPU 110 as the first process. In one embodiment, the memory 120 may be implemented as a RAM (Random Access Memory) corresponding to a volatile memory.

The I/O unit 130 may include an interface (hereinafter, referred as a local I/O interface) for reading or writing data from or into a nonvolatile memory (e.g., a hard disk) through a protocol such as USB, ATA (Advanced Technology Attachment), SCSI, ESDI and IDE (Integrated drive Electronics) and an interface (hereinafter, referred as a network I/O interface) for reading or writing data from or into the other communication party through a protocol such as Ethernet.

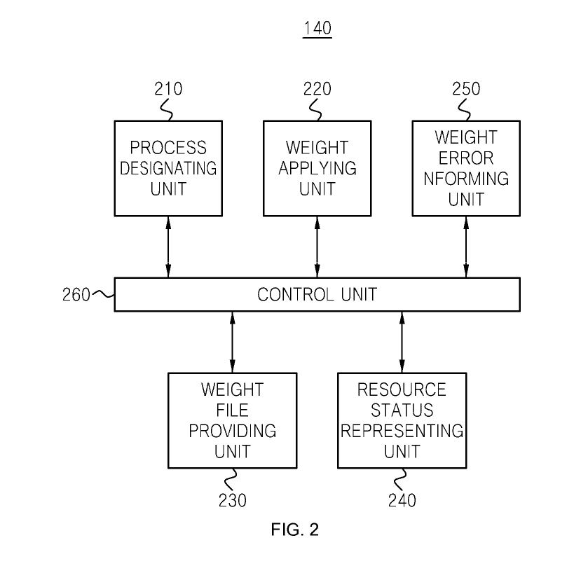

The resource status representing device 140 designates at least one process of the plurality of the processes to monitor a resource (e.g., CPU 110, memory 120 and I/O unit usages) of a corresponding process and applies a resource weight for each of the at least one process to visually represent. The resource weight may include a CPU weight, memory usage weight and I/O usage weight. The resource status representing device 140 will be described referring to FIG. 2.

The system bus 150 connects hardware such as the CPU 110, memory 120, I/O unit 130, resource status representing device 140 and storage device 160. In one embodiment, the system bus 150 may adopt a PCI (Peripheral Component Interconnect).

The storage device 160 includes a storage control unit 161 and storage unit 163. The storage control unit 161 controls the storage unit 163. The storage control unit 161 searches for a program stored in the storage unit 163 according to a request of the CPU 110 and transfers a corresponding process to the memory 120 through the system bus 150 when a corresponding program is searched. When the transfer is completed, the CPU 110 executes the corresponding process.

The storage unit 163 stores a boot image (BI) corresponding to an operating system of the computing apparatus 100 and a program associated with the second process. The boot image includes codes being required to operate the operating system and the CPU 110 loads the boot image on the memory 120 in an initial start process to prepare for executing another program. In one embodiment, the storage unit 163 may be implemented as the nonvolatile memory such as a ROM (Read Only Memory).

FIG. 2 is a block diagram illustrating a resource status representing apparatus of in FIG. 1.

Referring to FIG. 2, the resource status representing device 140 includes a process designating unit 210, weight applying unit 220, weight file providing unit 230 and resource status representing unit 240 and may further include a weight error informing unit 250 and control unit 260.

The process designating unit 210 may designate at least one process of a plurality of processes. In one embodiment, the process designating unit 210 may read a weight file including a resource weight vector for each of the at least one process to designate monitoring target processes. Herein, the resource weight vector includes a resource identifier, weight, minimum boundary and maximum boundary. In another embodiment, the process designating unit 210 may designate the at least one process selected by the user as the monitoring target processes.

The weight applying unit 220 applies the resource weight for each of the at least one process. In one embodiment, the weight applying unit 220 may assign the resource weight to each of resources associated with a process based on the weight file.

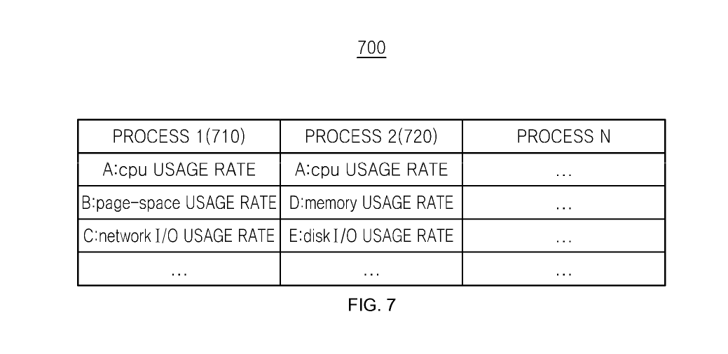

The weight file providing unit 230 provides the weight file including resource weight information applying to resources of each of the at least one process to the process designating unit 210 and weight applying unit 220. The weight file may include the resource weight vector for each of the at least one process and the resource weight vector may include the resource identifier, weight, minimum boundary and maximum boundary. The resource weight may include the CPU weight, memory usage weight and I/O usage weight. The weight file will be described in FIG. 7.

The resource status representing unit 240 visually represents each of the at least one process according to the resource weight. In one embodiment, the resource status representing unit 240 may visually represent each of the at least one process according to the resource weight by a user request or periodically. In one embodiment, the resource status representing unit 240 may represent the at least one process according to the resource weight on a stacked vertical bar graph or a stacked line graph. In one embodiment, the resource status representing unit 240 may detect a resource having a maximum resource weight associated with a resource when the resource weight is applied to the resource and represent the detected resource having the maximum resource weight with a specific color or pattern being designated by a system operator.

The weight error informing unit 250 generates an alarm sound when an error exists in the resource weight is applied to the resource for each of the at least one process. In one embodiment, when the resource applying the resource weight is less than the minimum boundary, the weight error informing unit 250 may inform an unusual operation to the system operator. In another embodiment, when the resource applying the resource weight exceeds the maximum boundary, the weight error informing unit 250 may inform the unusual operation to the system operator.

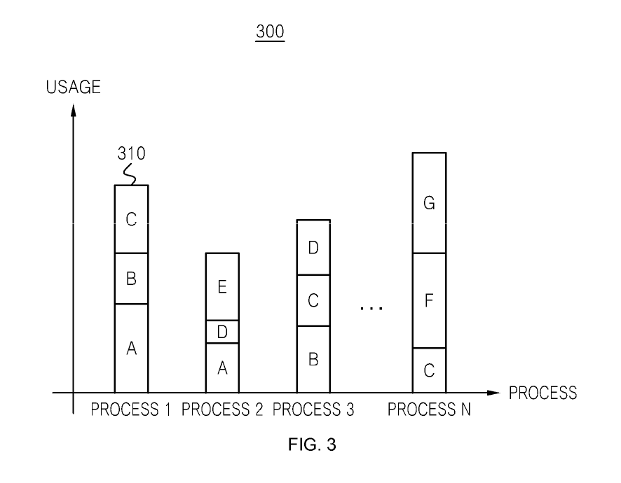

FIG. 3 is a stacked vertical bar graph representing each of processes by a process status representing unit in FIG. 2.

In FIG. 3, the resource status representing unit 240 may represent the at least one process according to the resource weight with the stacked vertical bar graph 300. The stacked vertical bar graph 300 indicates a process status on a current time. An X-axis of the stacked vertical bar graph 300 indicates the at least one process. In one embodiment, a process being selected by the user or included in the weight file may be represented on the X-axis of the stacked vertical bar graph 300. In one embodiment, the process being represented on the X-axis of the stacked vertical bar graph 300 may be represented by an ascending order, descending order or a predetermined order (e.g., an identifier order of the process) according to a usage rate or a total usage of a resource item being represented on a Y-axis of the stacked vertical bar graph 300.

The Y-axis of the stacked vertical bar graph 300 indicates the resource usage applying the weight associated with each of the at least one process. In one embodiment, the Y-axis of the stacked vertical bar graph 300 may apply a separate weight to a resource item influencing on the corresponding process of the at least one process to be stackedly represented by a vertical bar. The resource weight being applied to the resource item may be determined according to importance of the resource item. For example, when the resource item influencing on the corresponding process in a resource item of a specific process includes CPU, memory and disk 10 usage rates and the corresponding process is sensitive to the memory, a maximum resource weight may be applied to the memory usage rate.

In one embodiment, when the at least one process is identical to the resource item influencing on the corresponding process (e.g., an A item of process 1 and an A item of process 2), an identical weight or non-identical weight may be applied to each of the resource items.

In one embodiment, the resource item (e.g., resource A, B and C) in the stacked vertical bar 310 represented on the stacked vertical bar graph 300 may be stackedly represented in a descending order (e.g., in order by the resource A, C and B), an ascending order (e.g., in order by the resource B, C and A) of the applied resource weight or a random order. Therefore, the user may associate an important resource usage rate of the specific process, apply the resource weight to monitor/analyze the specific process in time, thereby the user may stably operate the system.

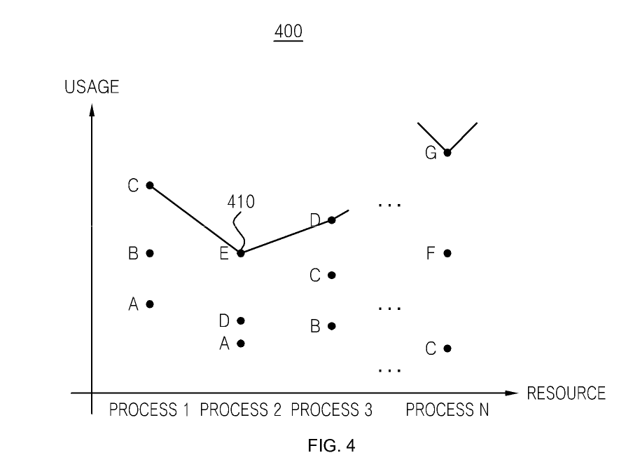

FIG. 4 is a stacked line graph representing each of processes by a process status representing unit in FIG. 2.

In FIG. 4, the resource status representing unit 240 may represent the at least one process according to the resource weight on a stacked line graph 400. The stacked line graph 400 indicates the process status of the current time. An X-axis of the stacked line graph 400 indicates the at least one process. In one embodiment, a process selected by the user or included in the weight file may be represented on the X-axis of the stacked line graph 400. In one embodiment, the process being represented on the X-axis of the stacked line graph 400 may be represented by an ascending order, descending order or a predetermined order according to a usage rate or a total usage of a resource item being represented on a Y-axis of the stacked line graph 400.

The Y-axis of the stacked line graph 400 indicates the resource usage that the resource applies the resource weight associated with each of the at least one process. In one embodiment, the Y-axis of the stacked line graph 400 may apply a separate weight to a resource item influencing on the corresponding process of the at least one process to be stackedly represented with a specific point. The resource weight being applied to the resource item may be determined according to the importance of the resource item.

In one embodiment, the resource item (e.g., resource A, D and E) corresponding to a stacked point 410 represented on the stacked line graph 400 may be stackedly represented in a descending order (e.g., in order by the resource E, A and D), an ascending order (e.g., in order by the resource D, A and E) of the applied resource weight or a random order.

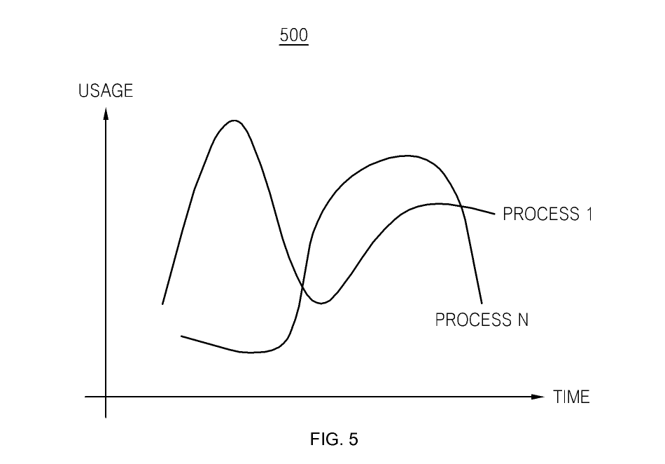

FIG. 5 is a graph representing each of processes by a process status representing unit in FIG. 2.

In FIG. 5, the resource status representing unit 240 may indicate the at least one process according to the resource weight on a graph 500. The graph 500 indicates a process pattern as time passes. A time may be represented on an X-axis of the graph 500. In one embodiment, the time being represented on the X-axis of the graph 500 may be represented by an ascending order, descending order or a predetermined order according to a usage rate or a total usage of a resource item being represented on a Y-axis of the graph 500.

The Y-axis of the graph 500 indicates a resource usage that the resource applies the resource weight associated with each of the at least one process. In one embodiment, a resource item influencing on the corresponding process of the at least one process may be represented on the Y-axis of the graph 500.

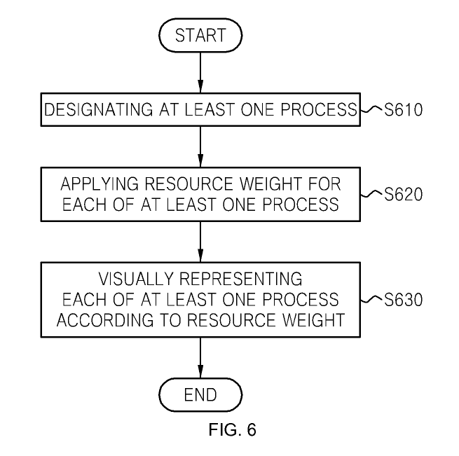

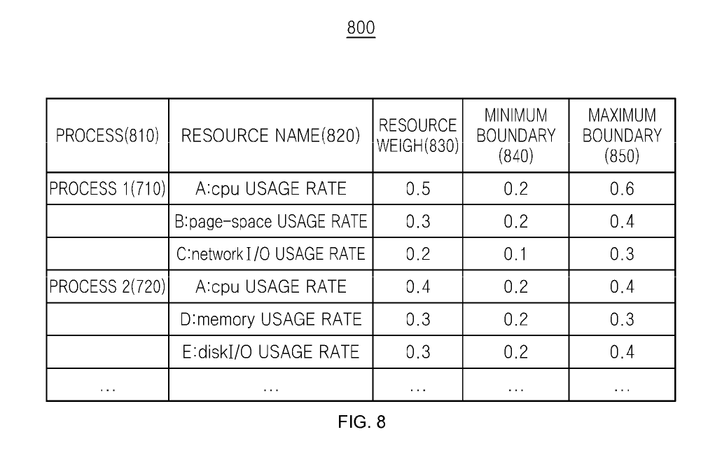

FIG. 6 is a flowchart illustrating a procedure executing a resource status representing apparatus in FIG. 1 and FIG. 7 and FIG. 8 are an example diagram of execution procedure in FIG. 6.

In FIG. 6 through FIG. 8, the process designating unit 210 may designate the at least one process of a plurality of processes (Step S610). In one embodiment, the process designating unit 210 may designate a monitoring target process based on the weight file. In another embodiment, the process designating unit 210 may designate at least one process selected by the user as the monitoring target process.

The weight applying unit 220 applies the resource weight for each of the at least one process (Step S620). In one embodiment, the weight applying unit 220 may apply a resource (e.g., a CPU, page-space or network 10 usage rate) influencing on the corresponding process (e.g., 710) for each of the at least one process. In one embodiment, the weight applying unit 220 based on following [Mathematical Equation 1] and [Mathematical Equation 2]

W(R)=C*W(R) [Mathematical Equation 1]

W(R): weight of corresponding resource

C: constant

W(R): step function being defined by importance of corresponding resource

Usage=Total(P(R*W(R))) [Mathematical Equation 1]

Usage: usage rate

Total(P): function calculating total resource usage rate of corresponding process

R: resource of corresponding process

W(R): weight of corresponding resource

In another embodiment, the weight applying unit 220 may apply the resource weight based on the weight file 800. The weight file 800 includes a resource weight vector for each of the at least one process (e.g., 710 and 720) and the resource weight vector includes the resource identifier 810, minimum boundary 830 and maximum boundary 840. The resource identifier 810 corresponds to a name of the monitoring target resource in a resource of the at least one process. The resource weight 820 is a value being assigned according resource importance. The minimum boundary 830 is a minimum value of a weight being applied to the resource and the maximum boundary 840 is a maximum value of the weight being applied to the resource. When the resource weight 830 is less than the minimum boundary or exceeds the maximum boundary, an alarm sound may be generated to inform an unusual operation of the corresponding process to the system operator.

The resource status representing unit 240 visually represent each of the at least one process according to the resource weight (Step S630). In one embodiment, the resource status representing unit 240 may visually represent each of the at least one process by a user request or periodically. In one embodiment, the resource status representing unit 240 may represent the at least one process according to the resource weight with the stacked vertical bar graph or stacked line graph.

Although embodiments have been described with reference to a number of illustrative embodiments thereof, it should be understood that numerous other modifications and embodiments can be devised by those skilled in the art that will fall within the spirit and scope of the principles of this disclosure.

1. A method of representing a usage of a monitoring resource, the method being performed on a computing apparatus executing a plurality of processes, the method comprising:
designating monitoring target processes based on a weight file including a resource weight, minimum and maximum values of the resource weight and a resource identifier, the resource weight being assigned according to resource importance for each of at least one process;
applying the resource weight to resource items including CPU, memory and I/O usage rates, the resource items influencing on each of the monitoring target processes; and
visually representing each of the monitoring target processes according to the applied resource weight by a user request or periodically.

2. The method of claim 1, further comprising:
informing an unusual operation of a corresponding process to a system operator when the resource weight associated with a corresponding resource for each of the monitoring target processes is less than the minimum value.

3. The method of claim 1, further comprising:
informing the unusual operation of the corresponding process to the system operator when the resource weight associated with the corresponding resource for each of the monitoring target processes exceeds the minimum value.

4. The method of claim 1, wherein visually representing each of the monitoring target processes includes
detecting a resource having a maximum resource weight associated with a corresponding resource for each of the monitoring target processes when the corresponding resource weight is applied; and
representing the resource having the maximum resource weight with a specific color or pattern being designated by the system operator.

5. A computing apparatus representing a usage of a monitoring resource, the computing apparatus comprising:
a process designating unit configured to designate monitoring target processes based on a weight file including a resource weight, minimum and maximum values of the resource weight and a resource identifier, the resource weight being assigned according to resource importance for each of at least one process;
a weight applying unit configured to apply the resource weight to resource items including CPU, memory and I/O usage rates, the resource items influencing on each of the monitoring target processes; and
a resource status representing unit configured to visually represent each of the monitoring target processes according to the applied resource weight by a user request or periodically.

6. The computing apparatus of claim 5, further comprising:
a weight error informing unit configured to inform an unusual operation of a corresponding process to a system operator when the resource weight associated with a corresponding resource for each of the monitoring target processes is less than the minimum value.

7. The computing apparatus of claim 6, wherein the weight error informing unit informs the unusual operation of the corresponding process to the system operator when the resource weight associated with the corresponding resource for each of the monitoring target processes exceeds the minimum value.

8. The computing apparatus of claim 5, wherein the resource status representing unit detects a resource having a maximum resource weight associated with a corresponding resource for each of the monitoring target processes when the corresponding resource weight is applied and represents the resource having the maximum resource weight with a specific color or pattern being designated by the system operator.

9. A non-transitory computer-readable medium storing a program executing a method of representing a usage of a monitoring resource, the method being performed on a computing apparatus executing a plurality of processes, the method comprising:
designating monitoring target processes based on a weight file including a resource weight, minimum and maximum values of the resource weight and a resource identifier, the resource weight being assigned according to resource importance for each of at least one process;
applying the resource weight to resource items including CPU, memory and I/O usage rates, the resource items influencing on each of the monitoring target processes; and
visually representing each of the monitoring target processes according to the applied resource weight by a user request or periodically.
